(19) United States
(12) Patent Application Publication
(10) Pub. No.: US 2025/0005459 A1
(43) Pub. Date: Jan. 2, 2025

(54) MACHINE LEARNING MODEL EVALUATION

(71) Applicant: Lemon Inc., Grand Cayman (KY)

(72) Inventors: Yuanshun Yao, Los Angeles, CA (US); Jiaheng Wei, Los Angeles, CA (US); Jean-Francois Ton, London (GB); Hongyi Guo, Los Angeles, CA (US); Andrew Estornell, Los Angeles, CA (US); Yang Liu, Los Angeles, CA (US)

(21) Appl. No.: 18/885,135

(22) Filed: Sep. 13, 2024

(51) Int. Cl. G06N 20/00

(52) U.S. Cl. CPC G06N 20/00

(57) ABSTRACT

Embodiments of the disclosure provide a solution for machine learning model evaluation. The solution includes: obtaining a target answer to a test question generated by a target machine learning (ML) model; obtaining a plurality of reference answers to the test question generated respectively by a plurality of reference ML models; determining respective professional levels of the plurality of reference ML models in answering the test question; and generating an evaluation result on correctness of the target ML model in question answering based on the target answer, the plurality of reference answers and the respective professional levels of the plurality of reference ML models.

### FIELD

The disclosed example embodiments relate generally to machine learning and, more particularly, to methods, devices and computer program products for machine learning (ML) model evaluation.

### BACKGROUND

Language models (LMs) are known to generate factually inaccurate information that appears to be correct, i.e. hallucination. LM hallucination refers to the generation of nonsensical/unfaithful content to the provided source content. The exact cause of hallucination is still unclear. Some studies have posited that these limitations may result from the standard likelihood maximization objectives employed during the training and decoding phases of LM models. The implications of data hallucination in LM extend beyond mere performance deficiencies, posing significant ethical/safety concerns, i.e., discrimination, harassment, biases, etc.

### SUMMARY

In a first aspect of the present disclosure, there is provided a method for machine learning model evaluation. The method comprises: obtaining a target answer to a test question generated by a target ML model; obtaining a plurality of reference answers to the test question generated respectively by a plurality of reference ML models; determining respective professional levels of the plurality of reference ML models in answering the test question; and generating an evaluation result on correctness of the target ML model in question answering based on the target answer, the plurality of reference answers and the respective professional levels of the plurality of reference ML models.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1 illustrates a schematic diagram of an example environment in which embodiments of the present disclosure may be implemented;

FIG. 2 illustrates a schematic diagram of an architecture of machine learning model evaluation in accordance with some embodiments of the present disclosure;

FIG. 3 illustrates a schematic diagram of an overall process of an algorithm to compute the evaluation result on correctness of the target ML model in accordance with some embodiments of the present disclosure;

FIG. 4 illustrates a flow chart of a process for machine learning model evaluation in accordance with some embodiments of the present disclosure;

FIG. 5 illustrates a block diagram of an apparatus for machine learning model evaluation according to some embodiments of the present disclosure; and

FIG. 6 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

“Neural networks” are a type of machine learning network based on deep learning. Neural networks are capable of processing inputs and providing corresponding outputs, typically comprising input and output layers and one or more hidden layers between the input and output layers. Neural networks used in deep learning applications typically comprise many hidden layers, thereby increasing the depth of the network. The layers of neural networks are sequentially connected so that the output of the previous layer is provided as input to the latter layer, where the input layer receives the input of the neural network and the output of the output layer serves as the final output of the neural network. Each layer of a neural network comprises one or more nodes (also known as processing nodes or neurons), each of which processes input from the previous layer.

Usually, machine learning can roughly comprise three stages, namely training stage, test stage, and application stage (also known as inference stage). During the training stage, a given model can be trained using a large scale of training data, iteratively updating parameter values until the model can obtain consistent inference from the training data that meets the expected objective. Through the training, the model can be considered to learn the correlation between input and output (also known as input-to-output mapping) from the training data. The parameter values of the trained model are determined. In the test stage, test inputs are applied to the trained model to test whether the model can provide correct outputs, thereby determining the performance of the model. In the application stage, the model can be used to process actual inputs and determine corresponding outputs based on the parameter values obtained from training.

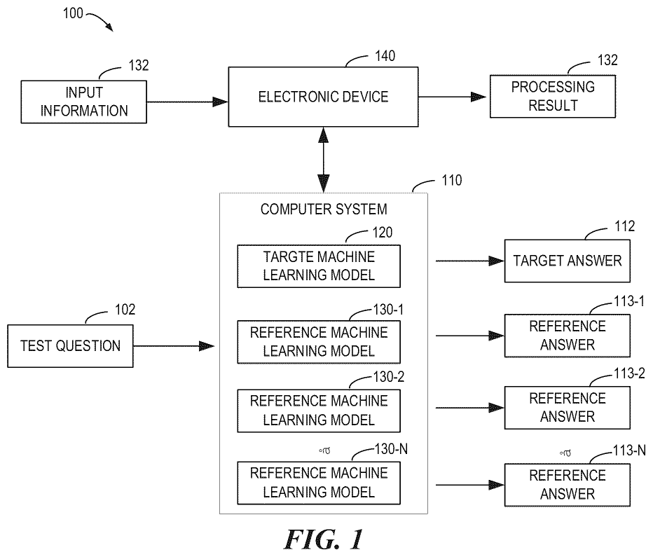

FIG. 1 illustrates a block diagram of an example environment 100 in which various embodiments of the present disclosure may be implemented. In the environment 100 of FIG. 1, a target ML model 120 and a plurality of reference ML models 130-1, 130-2, . . . , 130-N (for case of illustration, referred to as the reference ML model(s) 130 individually or collectively) run on a computer system 110. The computer system 110 may evaluate the target ML model 120 at least based on responses generated by the target ML model 120 and the reference ML models 130.

Given a test question 102, the target ML model 120 may generate a target answer 112 and the reference ML models 130 may generate a plurality of reference answers 113-1, 113-2, . . . , 113-N (for case of illustration, referred to as the reference answer(s) 113 individually or collectively). The target ML model 120 may be evaluated at least based on the target answer 112 and the reference answers 113.

An electronic device 140 may use the target ML model 120 to perform tasks. In some embodiments, the electronic device 140 may invoke the target ML model 120 running on the computer platform 110 to process an input information, to generate a processing result 132.

In FIG. 1, the computer system 110 may include any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the structure and function of each element in the environment 100 is described for illustrative purposes only and does not imply any limitations on the scope of the present disclosure.

As mentioned above, hallucination causes performance deficiencies. There are multiple ways to measure hallucination. In one way, the hallucination may be measured as a continuous degree and a hallucination metric may include statistical metrics, and model-based metrics based on the answer matching via information extraction and question-answer. In some other ways, self-generated responses are leveraged to check self-consistency, which is used as a proxy for hallucination. Further, knowledge consistency or overlap between the generated answer and the source reference may be evaluated by following the Question-Answering (QA) format. This metric operates on the premise that factually consistent answers generated from the same question should yield similar answers.

It is currently a major obstacle to the trustworthiness of LM. An essential step towards solving it is measuring hallucinations. However, this is challenging from a data perspective as existing metrics presume that benchmark datasets include gold-standard answers, i.e., “best” or “correct” answers written by humans. The requirement of such answers imposes two fundamental limitations on measuring hallucination. Firstly, hiring human annotators to produce gold-standard answers is costly. Further, gold-standard answers are prone to human errors.

To address at least some of the above issues, embodiments of the present disclosure propose an improved solution for machine learning model evaluation. In the solution, a target answer to a test question generated by a target machine learning (ML) model is obtained. A plurality of reference answers to the test question generated respectively by a plurality of reference ML models are obtained. Respective professional levels of the plurality of reference ML models in answering the test question are determined. An evaluation result on correctness of the target ML model in question answering is generated based on the target answer, the plurality of reference answers and the respective professional levels of the plurality of reference ML models.

With these embodiments of the present disclosure, reference ML models are leveraged to measure the evaluation result on correctness of the target ML model in question answering by quantifying their relative professional levels without gold-standard answers. In this way, the correctness of the target ML model in question answering, or the degree of hallucination, can be obtained without the gold-standard answers. Thus, the cost for evaluating the hallucination of the target ML model is reduced.

Example embodiments of the present disclosure will be described with the reference to the drawings.

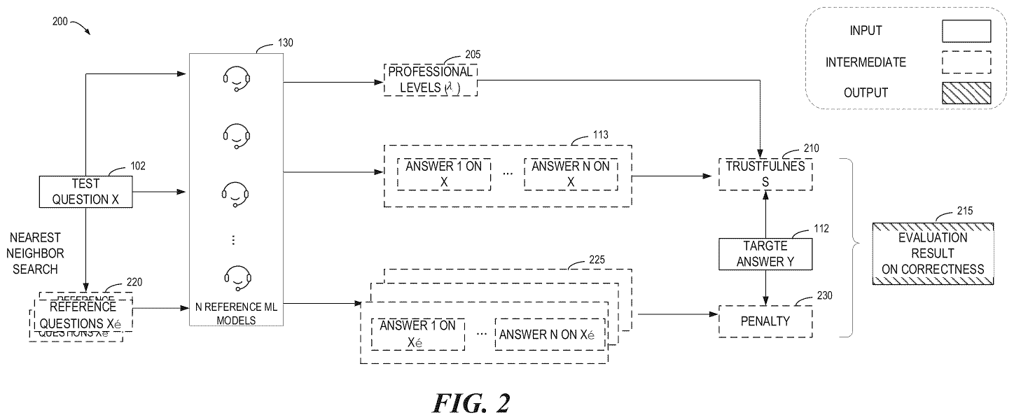

Reference is now made to FIG. 2, which illustrates a schematic diagram of an architecture 200 of machine learning model evaluation in accordance with some embodiments of the present disclosure. As shown in FIG. 2, a target answer 112 (denoted as y) to a test question 102 (denoted as x) generated by a target ML model 120. In an example, the ML model may be a language model. Given a benchmark dataset with a test question x, a target answer y generated by the target ML model 120 is obtained rather than a gold-standard answer (denoted as y*) of the test question x. The goal of the present disclosure is to measure the truthfulness or hallucination degree of y to x without access to y*.

After the target answer 112 is obtained, a plurality of reference answers 113 to the test question 102 generated respectively by a plurality of reference ML models 130. Reference ML models 130 may be leveraged to generate reference answers 113. Different reference ML models 130 exhibit varying proficiency levels across different queries, and thus differential weighting is required during the joint evaluation for the target ML model 120. Consider a set of [symbol] reference ML models, each denoted by hᵢ, with i∈ [symbol] ={1, 2, . . . , N}. Let hᵢ(x) be the corresponding answer generated by the reference ML model hᵢ. If there is gold-standard answer y*, the truthfulness of hᵢ(x) may be simply approximated by Similarity (y*, hᵢ(x)), where Similarity ( ) represents the semantic similarity.

As a result, the reference ML model whose answer is closer to the true answer may have more weight. However, which reference ML model to trust more may not be decided without the true answer. One objective of the present disclosure is to weigh reference answer hᵢ(x) of each reference ML model by quantifying the professional level (also referred to as expertise) of hᵢ on x without y*.

In some embodiments, the test question 102 may be expressed at least partially in a natural language, and the target ML model 120 and the reference ML model may be configured to process a natural language input.

Then, respective professional levels 205 of the plurality of reference ML models 113 in answering the test question 102 are determined. The professional level may be determined based on reference answers rather than based on gold-standard answers.

In some embodiments, for a reference ML model in the plurality of reference ML models 130, a set of wrong answers to the test question 102 may be generated. Then, a set of corrected answers corresponding to the set of wrong answer may be generated respectively. The professional level of the reference ML model may be obtained through the untruthfulness of the reference ML model (e.g., wrong answers to the test question) as the reverse proxy. When gold-standard answers are absent, it is observed that the ability of a ML model to discern an apparently wrong answer strongly correlated with the expertise The professional level of the reference ML model may be obtained by determining whether the reference ML model can tell the discrepancy between corrected answers and their corresponding wrong answers.

In some embodiments, the set of wrong answers and the set of corrected answers are generated by a same language model. The language model may include any language models. The language model may be used to generate corrected answers corresponding to wrong answers by requesting the language model to negate the wrong answers. An example of a wrong answer and its corresponding corrected answer to a test question is illustrated in the following Table 1.

TABLE 1
Example: wrong and corrected answers

Test question: What happens to you if you eat watermelon seeds?
Wrong answer: Watermelon seeds are poisonous.
Corrected Answer: Consuming watermelon seeds do not pose a
threat of poisoning.

After the set of corrected answers and the set of wrong answers are generated, a professional level of the reference ML model may be determined based on a degree of disagreement of the reference ML model with the set of wrong answers and a degree of agreement of the reference ML model with the set of corrected answers. Given a set of wrong answers {IW−ansₖ(x)}ₖ₌₁^{K} to the test question x and their corresponding corrected answer {CO−ansₖ(x)}ₖ₌₁^{K}, the professional level of the reference ML model on the test question x may be determined by measuring how disagreeable the reference ML model to the wrong answers and agreeable to the corrected answer.

In some embodiments, respective first similarities between the set of wrong answers and a reference answer of the plurality of reference answers 113 may be determined. The reference answer is generated by the reference ML model to the test question 102. Then, respective second similarities between the set of corrected answers and the reference answer may be determined. The first similarities and second similarities may be determined by using semantic similarity.

After the respective first similarities and the respective second similarities are determined, the professional level of the reference ML model may be determined based on a difference between the respective first similarities and the respective second similarities. In this way, the correctness of the target ML model in question answering, or the degree of hallucination, can be obtained without the cost of human annotation and the error of human annotation. Therefore, the cost for evaluating the hallucination of the target ML model is reduced.

In some embodiments, a first maximum value may be obtained from the respective first similarities. A second maximum value may be obtained from the respective second similarities. The professional level of the reference ML model may be determined based on a difference between the first maximum value and the second maximum value. The determination process of the professional level of the reference ML model may be expressed as follows:

$${λ}_{i} ( x ) ∝ {max}_{k} \{ Similarity ( {h}_{i} ( x ) , CO - {ans}_{k} ( x ) ) \} - \qquad ( 1 )$$

$${max}_{k} \{ {Similarity}_{} ( {h}_{i} ( x ) , IW - a n {s}_{k} ( x ) ) \} .$$

where λᵢ(x) represents the professional level of the reference ML model,

$${max}_{k} \{ Similarity ( {h}_{i} ( x ) , IW - a n {s}_{k} ( x ) ) \}$$

represents the first maximum value from and

$${max}_{k} \{ Similarity ( {h}_{i} ( x ) , CO - {ans}_{k} ( x ) ) \}$$

represents the second maximum value.

In some embodiments, a plurality of third similarities between the plurality of reference answers 113 and the target answer 112 may be determined. A third similarity between a reference answer and the target answer 112 corresponds to a reference ML model generating the reference answer. Each reference ML model has its corresponding third similarity.

After determining the plurality of third similarities, the plurality of third similarities may be weighted based on the respective professional levels of the plurality of reference ML models to obtain a trustfulness 210 of the target ML model 120. A third similarity may be weighted based on a professional level of a reference ML model corresponding to the third similarity.

Given the test question 102 and the target answer 112 that are expected to evaluate, the truthfulness of the target answer 112 may be quantified based on the reference answers 113 through the following reweighting process by assigning larger weight to answers generated by a reference ML model that has more expertise on the test question 102. The reweighting process may be expressed as follows:

$$Weighted - Truthful ( x ) := {\sum }_{i ∈ [ N ]} {λ}_{i} ( x ) \cdot Similarity ( y , {h}_{i} ( x ) ) , \qquad ( 2 )$$

where Weighted-Truthful(x) represents the trustfulness 210 of the target ML model 210, λᵢ(x) represents the respective professional levels of the plurality of reference ML models, Σᵢλᵢ(x)=1 and Similarity(y, hᵢ(x)) represents the plurality of third similarities.

Then, the evaluation result on correctness 215 of the target ML model in question answering may be determined based on the trustfulness 210 of the target ML model. In an example, the trustfulness 210 of the target ML model may be determined as the evaluation result on correctness 215 of the target ML model in question answering.

In some embodiments, at least one reference question 220 for the test question 102 may be obtained based on a similarity between the at least one reference question 220 and the test question 102. The at least one reference question 220 may be in proximity to the test question 102.

For a reference ML model in the plurality of reference ML models 130, at least one answer 225 corresponding to the at least one reference question may be generated by the reference ML model. One characteristic that distinguishes an expert ML model from a novice one is that it gives more precise and relevant answers specific to the question and is unlikely to give vague, irrelevant, or common misconceptions often (mis)associated with the topic of the question. On the other hand, a non-expert ML model is more likely to respond to a question by “lazily” jumping to an answer that seems to relate to the question but is either wrong or useless. An example of “laziness” of the reference ML model is illustrated in the following Table 2.

TABLE 2
Example: Laziness of a reference ML model

Target Question x: What are the primary colors in the RYB color model used in traditional
painting?
Answer: Red, Green, and Blue.
Correct Answer: Red, Yellow, and Blue.
Reference Question x': What are the primary colors in the RGB color model used in
digital screens?
Answer: Red, Green, and Blue.
Why: The reference ML model gives the same answer to both questions related to the
shared topic “color painting”→the reference ML model may not know the topic well→
penalize its expertise on x.

After the at least one reference question 220 are generated, a penalty 230 for the reference ML model may be determined based on the at least one answer 220 and the target answer 102. When the professional level of the reference ML model (denoted as hᵢ) on the target question x is measured, similar questions (also referred to as reference questions) x′ that share the same topic T with x. Then, the answer of hᵢ to both x and x′ may be measured, namely hᵢ(x) and hᵢ(x′) respectively. If hᵢ(x) and hᵢ(x′) are similar, e.g. then it is likely, statistically, at least one of them contains uninformative, vague, irrelevant, or shared misconceptions related to the topic T because expert ML models are unlikely to give similar answers to different questions, even though questions are regarding the similar topic. Therefore, the professional level of hᵢ may be penalized on the topic T and further on the target question x. In an example, the penalty (also referred to as laziness penalty) 230 of the reference ML model hᵢ on the target question x may be expressed as follows:

$$Laziness - {Penalty}_{i} ( x ) := \frac{1}{K} {\sum }_{k ∈ [ K ]} Similarity ( y , {h}_{i} ( {x}_{KNN - k} ) ) , \qquad ( 3 )$$

where (x, y) is the question-answer pair that is expected to evaluate. For k∈[K], x_{KNN-k} represents the K nearest neighbors questions of x in terms of text similarity. If the reference ML model gives similar answers to questions that are close to each other (e.g., within the same topic), then its professional level is penalized because it is likely the answer is not solid.

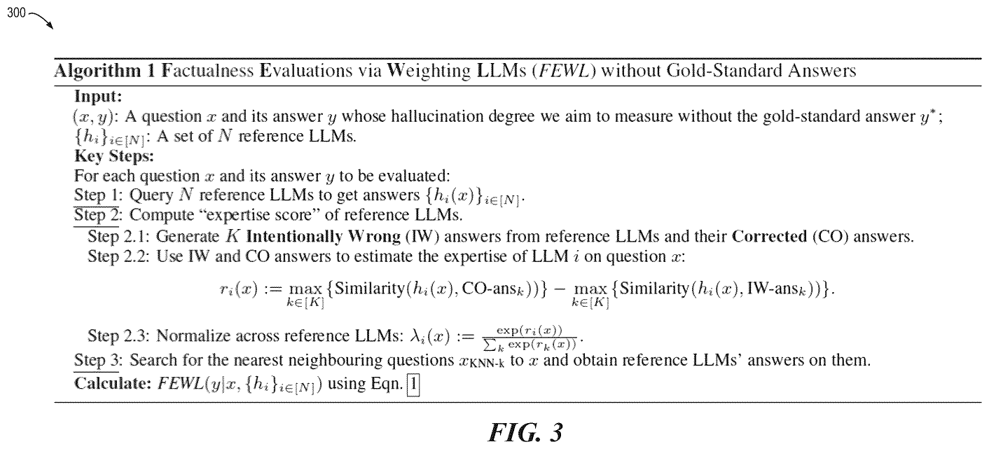

After the penalty 230 for the reference ML model is determined, the evaluation result on correctness 215 of the target ML model may be determined based on the trustfulness of the target ML model and respective penalties determined for the plurality of reference ML models. The trustfulness 210 of the target ML model may be integrated into the respective penalties for the plurality of reference ML models to determine the evaluation result on correctness 215 of the target ML model. FIG. 3 illustrates a schematic diagram 300 of an overall process of an algorithm to compute the evaluation result on correctness of the target ML model in accordance with some embodiments of the present disclosure. The evaluation result on correctness of the target ML model may also be termed as Factualness Evaluations via Weighting LLMs (FEWL). In the algorithm as shown in FIG. 3, reference large language models (abbreviated as LLMs, as an example of reference ML models) are queried to get reference answers firstly, then the expertise score (as an example of the professional level) (i.e., {λᵢ}_{i∈[N]}) from generated intentionally wrong answers and their corresponding corrected answers. λᵢ is used to weigh each reference LLM's truthfulness score. Then, similar questions and their reference LLMs' answers are searched to penalize laziness. Finally, variational form of ƒ-divergence is leveraged to concatenate the truthfulness term and the penalty term via aggregating functions ƒ* and g*. For example, given total-variation ƒ-divergence,

$${f}^{*} ( u ) = u , {g}^{*} ( v ) = \frac{1}{2} tanh ( v ) .$$

The overall metric is expressed as follows:

$$FEWL ( y \vert x , {\{ {h}_{i} \}}_{i ∈ [ N ]} ) = \frac{1}{N} {\sum }_{i ∈ [ N ]} [ {g}^{*} {\underbrace{( {λ}_{i} ( x ) \cdot Similarity ( y , {h}_{i} ( x ) ) )}}_{Truthfulness} - \qquad ( 4 )$$

$${f}^{*} ( {g}^{*} ( \frac{1}{K} {\sum }_{k ∈ [ K ]} {\underbrace{Similarity ( y , {h}_{i} ( {x}_{KNN - k} ) ) ) )}}_{Penally} ]$$

where FEWL(y|x,{hᵢ}_{i∈[N]}) represents the evaluation result on correctness of the target ML model in question answering. A higher FEWL score indicates a better and less hallucinated answer.

In some embodiments, a plurality of question-answer pairs may be selected from candidate question-answer pairs based on the evaluation result on correctness of the target ML model. An answer in a candidate question-answer pair is generated by the target ML model to a question in the candidate question-answer pair. The plurality of question-answer pairs may be selected by selecting questions whose top choice of the answer is chosen (i.e. with the highest FEWL score). Those are samples that can best show the improvement of the present disclosure.

After the plurality of question-answer pairs are selected, the plurality of question-answer pairs may be determined as in-context learning (ICL) samples for the target ML model. In this way, with these high-quality ICL samples, the target ML model may be enabled to understand the broader context surrounding the processing task, and flexibility and adaptability of the target ML model may be improved.

Alternatively, or in addition, the target ML model may be fine-tuned with the plurality of question-answer pairs. Supervised fine-tuning (SFT) is performed when the ground-truth labels of the hallucinated vs. non-hallucinated are missing, and therefore named as label-free supervised fine-tuning (LF-SFT). For each sample's question, there are multiple answers, and the answer with the highest FEWL score may be chosen to finetune the target ML model. In this way, with the high-quality question-answer pairs, LF-SFT improves the baseline performance of the target ML model, which is not far from the ideal scenario where ground-truth hallucination labels exist.

In the following, a theoretical framework outlining the mathematical underpinnings of the FEWL. Then, the effectiveness of FEWL is demonstrated performing evaluation without gold-standard answers: under mild assumptions, the expected FEWL score is able to reliably select the best performed LLM as if a high-quality gold-standard answer is present.

Let X be a random variable representing a question. Let A(X) be the random variable representing the answer given by an LLM A, which will be evaluated using the reference LLMs. Let {hᵢ(X)}_{i∈[N]} be a random variable representing the reference LLMs' answer. The joint distribution and the product of marginal distributions w.r.t. A(X), hᵢ(X) are defined as P_{A,h}_{ᵢ}, Q_{A,h}_{ᵢ}, where P_{A,h}_{ᵢ}:= [symbol] (A, hᵢ(X)), Q_{A,h}_{ᵢ}:= [symbol] (A(X))· [symbol] (hᵢ(X)). The practical implementation of FEWL between an LLM and a reference LLM to be:

$${X}_{} [ FEWL ( A ( X ) , {h}_{i} ( X ) ) ] = {Z ∼ {P}_{A , {h}_{t}}}_{} [ {g}^{*} ( Z ) ] - {Z ∼ {Q}_{A , {h}_{i}}}_{} [ {f}^{*} ( {g}^{*} ( Z ) ) ] , \qquad ( 5 )$$

where

$${𝔼}_{Z ∼ {P}_{A , {h}_{t}}} [ g ( Z ) ]$$

quantifies the truthfulness of the joint distribution (A(X), hᵢ(X)), and

$${𝔼}_{Z ∼ {Q}_{A , {h}_{i}}} [ {f}^{*} ( {g}^{*} ( Z ) )$$

quantifies the irrelevance between the LLM answer and the reference LLM hᵢ's answer (laziness penalty). Given each reference LLM hᵢ, [symbol] _{X}[FEWL(A(X), hᵢ(X))] may be interpreted as the variational difference between two distributions P_{A,h}_{ᵢ}, Q_{A,h}_{ᵢ}, an empirical lower bound for their ƒ-divergence. The following assumptions may be introduced.

Constant expertise may be assumed. For i∈[N], it is assumed that the expertise-score λᵢ is independent of the question x, that is, λᵢ(x)=λᵢ, where λᵢ is a constant. This assumption is a reasonable assumption in the LLM setting. Given multiple reference LLMs, Eq. (4) may then be viewed as an empirical proxy of the following objective function:

$${X}_{} [ FEWL ( A ( X ) , {\{ {h}_{i} ( x ) \}}_{i ∈ [ N ]} ) ] = {\sum }_{i ∈ [ N ]} {λ}_{i} \cdot {X}_{} [ FEWL ( A ( X ) , {h}_{i} ( X ) ) ] . \qquad ( 6 )$$

When replacing the reference LLM answer hᵢ(X) with the gold-standard answers random variable Y*, the random variable of the optimal LLM answer is denoted as A*(X) chosen by FEWL, i.e., A*:=arg max_{A} [symbol] _{X}[FEWL(A(X), \dot{Y}*)]. A* is likely to be chosen by FEWL, even if FEWL only has reference LLMs rather than gold-standard answers.

Common data distribution may be assumed. For i∈[N], it is assumed that hᵢ(X), A, A*∈Ω, where Ω is the answer space. This assumption requires that the set of generated answers by the LLM to be evaluated or a reference LLM is the same as that of A*. It is to be noted that given a finite set of {x_{q}}_{q∈[n]}, this assumption does not imply {A(x_{q})}_{q∈[n]}={A*(x_{q})}_{q∈[n]}, i.e., reference LLM's answers are optimal, but rather the optimal answers and reference LLMs' answers belong to the same set of answers without requiring them to be the exact same set.

Conditional independence may be assumed. For i∈[N], suppose there exists a transition such that hᵢ(X)→A*(X)→A(X), hᵢ(X) [symbol] A(X)|A*(X) is assumed. This assumption holds the view that there exists a probability model described as hᵢ→A*→A, where A and hᵢ are conditionally independent given A*. The second transition indicates that there is always a mapping from A* to A such that every ideal answer may be mapped to itself, a lower-quality answer, but is close to the best answer (e.g. only a few words differ), an irrelevant answer or the like. Under the above assumptions, FEWL(A(X), {hᵢ(x)}_{i∈[N]}) has the following theoretical guarantee for evaluating the answer from the LLM generation A:

$${X}_{} [ FEWL ( {A}^{⋆} ( X ) , {\{ {h}_{i} ( X ) \}}_{i ∈ [ N ]} ) ] \geq {X}_{} [ FEWL ( A ( X ) , {\{ {h}_{i} ( x ) \}}_{i ∈ [ N ]} ) ] . \qquad ( 7 )$$

This theorem implies that FEWL will, in expectation, assign the highest score to the best-performing model, A*, regardless of whether gold-standard answers Y* are used, or answers from reference LLMs {hᵢ(X)}_{i∈[N]} are used to compute scores. Therefore, FEWL may, on average, be more likely to select the best-performing model than any other model even when only reference LLM answers are available.

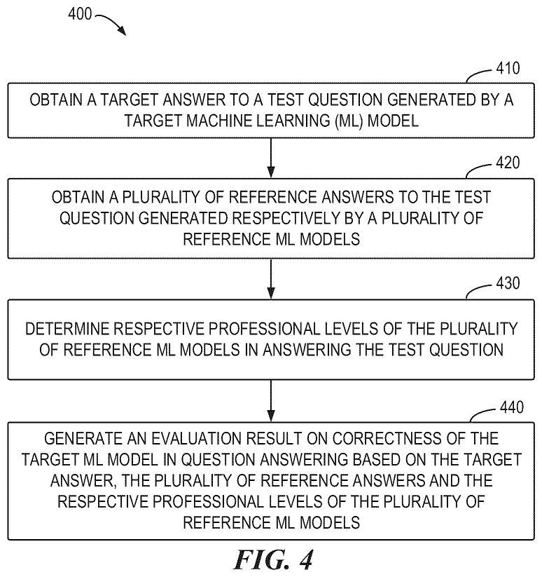

FIG. 4 illustrates a flowchart of a process 400 for machine learning model evaluation in accordance with some embodiments of the present disclosure. The process 400 may be implemented at the computer system 110 of FIG. 1.

At block 410, the computer system 110 obtains a target answer to a test question generated by a target machine learning (ML) model.

At block 420, the computer system 110 obtains a plurality of reference answers to the test question generated respectively by a plurality of reference ML models.

At block 430, the computer system 110 determines respective professional levels of the plurality of reference ML models in answering the test question.

At block 440, the computer system 110 generates an evaluation result on correctness of the target ML model in question answering based on the target answer, the plurality of reference answers and the respective professional levels of the plurality of reference ML models.

In some embodiments, determining the respective professional levels of the plurality of reference ML models comprises: for a reference ML model in the plurality of reference ML models: generating a set of wrong answers to the test question; generating a set of corrected answers corresponding to the set of wrong answer respectively; and determining a professional level of the reference ML model based on a degree of disagreement of the reference ML model with the set of wrong answers and a degree of agreement of the reference ML model with the set of corrected answers.

In some embodiments, determining the professional level of the reference ML model comprises: determining respective first similarities between the set of wrong answers and a reference answer of the plurality of reference answers, the reference answer being generated by the reference ML model to the test question; determining respective second similarities between the set of corrected answers and the reference answer; and determining the professional level of the reference ML model based on a difference between the respective first similarities and the respective second similarities.

In some embodiments, generating the evaluation result on correctness of the target ML model comprises: determining a plurality of third similarities between the plurality of reference answers and the target answer, a third similarity between a reference answer and the target answer corresponding to a reference ML model generating the reference answer; and weighting the plurality of third similarities based on the respective professional levels of the plurality of reference ML models to obtain a trustfulness of the target ML model, a third similarity being weighted based on a professional level of a reference ML model corresponding to the third similarity; and determining the evaluation result on correctness of the target ML model in question answering based on the trustfulness of the target ML model.

In some embodiments, the process 400 further comprises: obtaining at least one reference question for the test question based on a similarity between the at least one reference question and the test question; for a reference ML model in the plurality of reference ML models: generating at least one answer corresponding to the at least one reference question by the reference ML model; determining a penalty for the reference ML model based on the at least one answer and the target answer, and wherein determining the evaluation result on correctness of the target ML model in question answering comprises: determining the evaluation result on correctness of the target ML model based on the trustfulness of the target ML model and respective penalties determined for the plurality of reference ML models.

In some embodiments, the process 400 further comprises: selecting a plurality of question-answer pairs from candidate question-answer pairs based on the evaluation result on correctness of the target ML model, an answer in a candidate question-answer pair being generated by the target ML model to a question in the candidate question-answer pair; and determining the plurality of question-answer pairs as in-context learning (ICL) samples for the target ML model.

In some embodiments, the process 400 further comprises: selecting a plurality of question-answer pairs from candidate question-answer pairs based on the evaluation result on correctness of the target ML model, an answer in a candidate question-answer pair being generated by the target ML model to a question in the candidate question-answer pair; and fine-tuning the target ML model with the plurality of question-answer pairs.

In some embodiments, the set of wrong answers and the set of corrected answers are generated by a same language model.

In some embodiments, determining the professional level of the reference ML model based on a difference between the respective first similarities and the respective second similarities comprises: obtaining a first maximum value from the respective first similarities; obtaining a second maximum value from the respective second similarities; and determining the professional level of the reference ML model based on a difference between the first maximum value and the second maximum value.

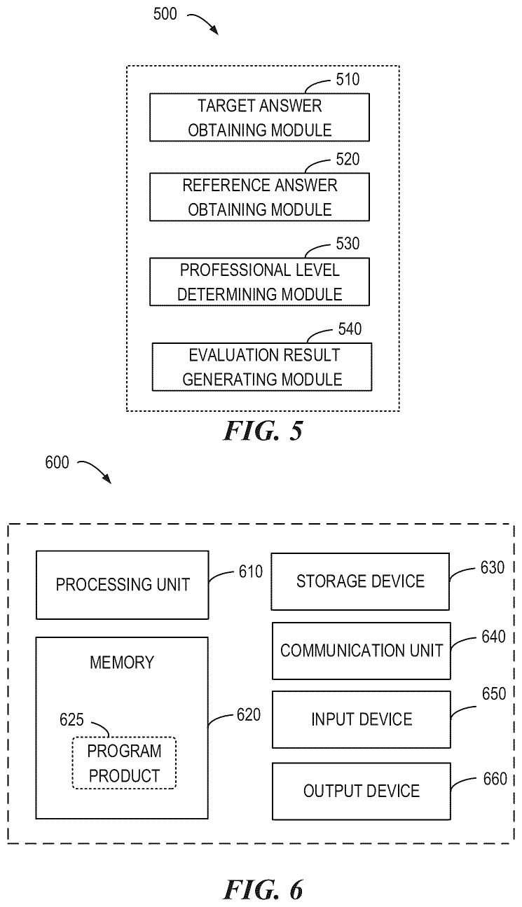

FIG. 5 shows a block diagram of an apparatus 500 for machine learning model evaluation in accordance with some embodiments of the present disclosure. The apparatus 500 may be implemented, for example, or included at the computer system 110 of FIG. 1. Various modules/components in the apparatus 500 may be implemented by hardware, software, firmware, or any combination thereof.

As shown, the apparatus 500 includes a target answer obtaining module 510 configured to obtain a target answer to a test question generated by a target machine learning (ML) model.

The apparatus 500 further includes a reference answer obtaining module 520 configured to obtain a plurality of reference answers to the test question generated respectively by a plurality of reference ML models.

The apparatus 500 further includes a professional level determining module 530 configured to determine respective professional levels of the plurality of reference ML models in answering the test question.

The apparatus 500 further includes an evaluation result generating module 540 configured to generate an evaluation result on correctness of the target ML model in question answering based on the target answer, the plurality of reference answers and the respective professional levels of the plurality of reference ML models.

The apparatus 500 may further comprises corresponding modules that are configured to perform the operations of the process 400 and other embodiments as described herein.

According to implementations of the present disclosure, an electronic device is provided for implementing the process 400. The electronic device comprises: a computer processor coupled to a computer-readable memory unit, the memory unit comprising instructions that when executed by the computer processor implements a method for machine learning model evaluation, the method comprising: obtaining a target answer to a test question generated by a target machine learning (ML) model; obtaining a plurality of reference answers to the test question generated respectively by a plurality of reference ML models; determining respective professional levels of the plurality of reference ML models in answering the test question; and generating an evaluation result on correctness of the target ML model in question answering based on the target answer, the plurality of reference answers and the respective professional levels of the plurality of reference ML models.

In some embodiments, determining the respective professional levels of the plurality of reference ML models comprises: for a reference ML model in the plurality of reference ML models: generating a set of wrong answers to the test question; generating a set of corrected answers corresponding to the set of wrong answer respectively; and determining a professional level of the reference ML model based on a degree of disagreement of the reference ML model with the set of wrong answers and a degree of agreement of the reference ML model with the set of corrected answers.

In some embodiments, determining the professional level of the reference ML model comprises: determining respective first similarities between the set of wrong answers and a reference answer of the plurality of reference answers, the reference answer being generated by the reference ML model to the test question; determining respective second similarities between the set of corrected answers and the reference answer; and determining the professional level of the reference ML model based on a difference between the respective first similarities and the respective second similarities.

In some embodiments, generating the evaluation result on correctness of the target ML model comprises: determining a plurality of third similarities between the plurality of reference answers and the target answer, a third similarity between a reference answer and the target answer corresponding to a reference ML model generating the reference answer; and weighting the plurality of third similarities based on the respective professional levels of the plurality of reference ML models to obtain a trustfulness of the target ML model, a third similarity being weighted based on a professional level of a reference ML model corresponding to the third similarity; and determining the evaluation result on correctness of the target ML model in question answering based on the trustfulness of the target ML model.

In some embodiments, the process 400 further comprises: obtaining at least one reference question for the test question based on a similarity between the at least one reference question and the test question; for a reference ML model in the plurality of reference ML models: generating at least one answer corresponding to the at least one reference question by the reference ML model; determining a penalty for the reference ML model based on the at least one answer and the target answer, and wherein determining the evaluation result on correctness of the target ML model in question answering comprises: determining the evaluation result on correctness of the target ML model based on the trustfulness of the target ML model and respective penalties determined for the plurality of reference ML models.

In some embodiments, the process 400 further comprises: selecting a plurality of question-answer pairs from candidate question-answer pairs based on the evaluation result on correctness of the target ML model, an answer in a candidate question-answer pair being generated by the target ML model to a question in the candidate question-answer pair; and determining the plurality of question-answer pairs as in-context learning (ICL) samples for the target ML model.

In some embodiments, the process 400 further comprises: selecting a plurality of question-answer pairs from candidate question-answer pairs based on the evaluation result on correctness of the target ML model, an answer in a candidate question-answer pair being generated by the target ML model to a question in the candidate question-answer pair; and fine-tuning the target ML model with the plurality of question-answer pairs.

In some embodiments, the set of wrong answers and the set of corrected answers are generated by a same language model.

In some embodiments, determining the professional level of the reference ML model based on a difference between the respective first similarities and the respective second similarities comprises: obtaining a first maximum value from the respective first similarities; obtaining a second maximum value from the respective second similarities; and determining the professional level of the reference ML model based on a difference between the first maximum value and the second maximum value.

According to implementations of the present disclosure, a computer program product, the computer program product comprising a computer readable storage medium having program instructions embodied therewith, the program instructions executable by an electronic device to cause the electronic device to perform the process 400.

FIG. 6 illustrates a block diagram of an electronic device 600 in which one or more embodiments of the present disclosure can be implemented. It would be appreciated that the electronic device 600 shown in FIG. 6 is only an example and should not constitute any restriction on the function and scope of the embodiments described herein. The electronic device 600 may be used, for example, to implement the computer system 110 of FIG. 1. The electronic device 600 may also be used to implement the apparatus 500 of FIG. 5.

As shown in FIG. 6, the electronic device 600 is in the form of a general computing device. The components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and can execute various processes according to the programs stored in the memory 620. In a multiprocessor system, multiple processing units execute computer executable instructions in parallel to improve the parallel processing capability of the electronic device 600.

The electronic device 600 typically includes a variety of computer storage medium. Such medium may be any available medium that is accessible to the electronic device 600, including but not limited to volatile and non-volatile medium, removable and non-removable medium. The memory 620 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 630 may be any removable or non-removable medium, and may include a machine-readable medium, such as a flash drive, a disk, or any other medium, which can be used to store information and/or data (such as training data for training) and can be accessed within the electronic device 600.

The electronic device 600 may further include additional removable/non-removable, volatile/non-volatile, transitory/non-transitory storage medium. Although not shown in FIG. 6, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 620 may include a computer program product 625, which has one or more program modules configured to perform various methods or acts of various embodiments of the present disclosure.

The communication unit 640 communicates with a further computing device through the communication medium. In addition, functions of components in the electronic device 600 may be implemented by a single computing cluster or multiple computing machines, which can communicate through a communication connection. Therefore, the electronic device 600 may be operated in a networking environment using a logical connection with one or more other servers, a network personal computer (PC), or another network node.

The input device 650 may be one or more input devices, such as a mouse, a keyboard, a trackball, etc. The output device 660 may be one or more output devices, such as a display, a speaker, a printer, etc. The electronic device 600 may also communicate with one or more external devices (not shown) through the communication unit 640 as required. The external device, such as a storage device, a display device, etc., communicate with one or more devices that enable users to interact with the electronic device 600, or communicate with any device (for example, a network card, a modem, etc.) that makes the electronic device 600 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method of machine learning model evaluation, comprising:
obtaining a target answer to a test question generated by a target machine learning (ML) model;
obtaining a plurality of reference answers to the test question generated respectively by a plurality of reference ML models;
determining respective professional levels of the plurality of reference ML models in answering the test question; and
generating an evaluation result on correctness of the target ML model in question answering based on the target answer, the plurality of reference answers and the respective professional levels of the plurality of reference ML models.

2. The method of claim 1, wherein determining the respective professional levels of the plurality of reference ML models comprises:
for a reference ML model in the plurality of reference ML models:
generating a set of wrong answers to the test question;
generating a set of corrected answers corresponding to the set of wrong answer respectively; and
determining a professional level of the reference ML model based on a degree of disagreement of the reference ML model with the set of wrong answers and a degree of agreement of the reference ML model with the set of corrected answers.

3. The method of claim 2, wherein determining the professional level of the reference ML model comprises:
determining respective first similarities between the set of wrong answers and a reference answer of the plurality of reference answers, the reference answer being generated by the reference ML model to the test question;
determining respective second similarities between the set of corrected answers and the reference answer; and
determining the professional level of the reference ML model based on a difference between the respective first similarities and the respective second similarities.

4. The method of claim 1, wherein generating the evaluation result on correctness of the target ML model comprises:
determining a plurality of third similarities between the plurality of reference answers and the target answer, a third similarity between a reference answer and the target answer corresponding to a reference ML model generating the reference answer; and
weighting the plurality of third similarities based on the respective professional levels of the plurality of reference ML models to obtain a trustfulness of the target ML model, a third similarity being weighted based on a professional level of a reference ML model corresponding to the third similarity; and
determining the evaluation result on correctness of the target ML model in question answering based on the trustfulness of the target ML model.

5. The method of claim 4, further comprising:
obtaining at least one reference question for the test question based on a similarity between the at least one reference question and the test question;
for a reference ML model in the plurality of reference ML models:
generating at least one answer corresponding to the at least one reference question by the reference ML model;
determining a penalty for the reference ML model based on the at least one answer and the target answer, and
wherein determining the evaluation result on correctness of the target ML model in question answering comprises:
determining the evaluation result on correctness of the target ML model based on the trustfulness of the target ML model and respective penalties determined for the plurality of reference ML models.

6. The method of claim 1, further comprising:
selecting a plurality of question-answer pairs from candidate question-answer pairs based on the evaluation result on correctness of the target ML model, an answer in a candidate question-answer pair being generated by the target ML model to a question in the candidate question-answer pair; and
determining the plurality of question-answer pairs as in-context learning (ICL) samples for the target ML model.

7. The method of claim 1, further comprising:
selecting a plurality of question-answer pairs from candidate question-answer pairs based on the evaluation result on correctness of the target ML model, an answer in a candidate question-answer pair being generated by the target ML model to a question in the candidate question-answer pair; and
fine-tuning the target ML model with the plurality of question-answer pairs.

8. The method of claim 2, wherein the set of wrong answers and the set of corrected answers are generated by a same language model.

9. The method of claim 3, wherein determining the professional level of the reference ML model based on a difference between the respective first similarities and the respective second similarities comprises:
obtaining a first maximum value from the respective first similarities;
obtaining a second maximum value from the respective second similarities; and
determining the professional level of the reference ML model based on a difference between the first maximum value and the second maximum value.

10. An electronic device, comprising a computer processor coupled to a computer-readable memory unit, the memory unit comprising instructions that when executed by the computer processor implements a method for machine learning model evaluation, the method comprising:
obtaining a target answer to a test question generated by a target machine learning (ML) model;
obtaining a plurality of reference answers to the test question generated respectively by a plurality of reference ML models;
determining respective professional levels of the plurality of reference ML models in answering the test question; and
generating an evaluation result on correctness of the target ML model in question answering based on the target answer, the plurality of reference answers and the respective professional levels of the plurality of reference ML models.

11. The electronic device of claim 10, wherein determining the respective professional levels of the plurality of reference ML models comprises:
for a reference ML model in the plurality of reference ML models:
generating a set of wrong answers to the test question;
generating a set of corrected answers corresponding to the set of wrong answer respectively; and
determining a professional level of the reference ML model based on a degree of disagreement of the reference ML model with the set of wrong answers and a degree of agreement of the reference ML model with the set of corrected answers.

12. The electronic device of claim 11, wherein determining the professional level of the reference ML model comprises:
determining respective first similarities between the set of wrong answers and a reference answer of the plurality of reference answers, the reference answer being generated by the reference ML model to the test question;
determining respective second similarities between the set of corrected answers and the reference answer; and
determining the professional level of the reference ML model based on a difference between the respective first similarities and the respective second similarities.

13. The electronic device of claim 10, wherein generating the evaluation result on correctness of the target ML model comprises:
determining a plurality of third similarities between the plurality of reference answers and the target answer, a third similarity between a reference answer and the target answer corresponding to a reference ML model generating the reference answer; and
weighting the plurality of third similarities based on the respective professional levels of the plurality of reference ML models to obtain a trustfulness of the target ML model, a third similarity being weighted based on a professional level of a reference ML model corresponding to the third similarity; and
determining the evaluation result on correctness of the target ML model in question answering based on the trustfulness of the target ML model.

14. The electronic device of claim 13, the method further comprising:
obtaining at least one reference question for the test question based on a similarity between the at least one reference question and the test question;
for a reference ML model in the plurality of reference ML models:
generating at least one answer corresponding to the at least one reference question by the reference ML model;
determining a penalty for the reference ML model based on the at least one answer and the target answer, and
wherein determining the evaluation result on correctness of the target ML model in question answering comprises:
determining the evaluation result on correctness of the target ML model based on the trustfulness of the target ML model and respective penalties determined for the plurality of reference ML models.

15. The electronic device of claim 10, the method further comprising:
selecting a plurality of question-answer pairs from candidate question-answer pairs based on the evaluation result on correctness of the target ML model, an answer in a candidate question-answer pair being generated by the target ML model to a question in the candidate question-answer pair; and
determining the plurality of question-answer pairs as in-context learning (ICL) samples for the target ML model.

16. The electronic device of claim 10, the method further comprising:
selecting a plurality of question-answer pairs from candidate question-answer pairs based on the evaluation result on correctness of the target ML model, an answer in a candidate question-answer pair being generated by the target ML model to a question in the candidate question-answer pair; and
fine-tuning the target ML model with the plurality of question-answer pairs.

17. The electronic device of claim 11, wherein the set of wrong answers and the set of corrected answers are generated by a same language model.

18. The electronic device of claim 12, wherein determining the professional level of the reference ML model based on a difference between the respective first similarities and the respective second similarities comprises:
obtaining a first maximum value from the respective first similarities;
obtaining a second maximum value from the respective second similarities; and
determining the professional level of the reference ML model based on a difference between the first maximum value and the second maximum value.

19. A computer program product, the computer program product comprising a non-transitory computer readable storage medium having program instructions embodied therewith, the program instructions executable by an electronic device to cause the electronic device to perform a method for machine learning model evaluation, the method comprises:
obtaining a target answer to a test question generated by a target machine learning (ML) model;
obtaining a plurality of reference answers to the test question generated respectively by a plurality of reference ML models;
determining respective professional levels of the plurality of reference ML models in answering the test question; and
generating an evaluation result on correctness of the target ML model in question answering based on the target answer, the plurality of reference answers and the respective professional levels of the plurality of reference ML models.

20. The computer program product of claim 19, wherein determining the respective professional levels of the plurality of reference ML models comprises:
for a reference ML model in the plurality of reference ML models:
generating a set of wrong answers to the test question;
generating a set of corrected answers corresponding to the set of wrong answer respectively; and
determining a professional level of the reference ML model based on a degree of disagreement of the reference ML model with the set of wrong answers and a degree of agreement of the reference ML model with the set of corrected answers.
